(19) United States
(12) Patent Application Publication
(10) Pub. No.: US 2025/0254186 A1
(43) Pub. Date: Aug. 7, 2025

(54) CONFIDENCE-BASED EVENT GROUP MANAGEMENT, WORKFLOW EXPLOITATION AND ANOMALY DETECTION

(71) Applicant: INTERNATIONAL BUSINESS MACHINES CORPORATION, ARMONK, NY (US)

(72) Inventors: YUK LUNG CHAN, ROCHESTER, NY (US); TIM BROOKS, CARY, NC (US); YU CHUN SHI, SHANGHAI (CN); YUAN YUAN GONG, SHANGHAI (CN); YIN HU, NINGBO (CN); JASON WARNER, CEDAR PARK, TX (US); STEVEN LAFALCE, SALT POINT, NY (US); RICHARD A. LYLES, WAKE FOREST, NC (US); TIMOTHY BURLEY, RALEIGH, NC (US); VENKAT MALIREDDI, APEX, NC (US); MATTHEW S. AIKEN, MORRISVILLE, NC (US); WILLIAM JAMES BARTOLOMEO, PINE PLAINS, NY (US); CHRISTOPHER T. MURPHY, DURHAM, NC (US); CYRIL NESTOR, CARY, NC (US)

(21) Appl. No.: 18/430,339

(22) Filed: Feb. 1, 2024

(51) Int. Cl. H04L 9/40

(52) U.S. Cl. CPC H04L 63/1425

(57) ABSTRACT

Confidence-based event group management, workflow exploitation and anomaly detection, including: detecting an event in a computing system; adding the event to an event group; and calculating a group confidence level for the event group based on an event confidence level for the event and at least one of: one or more attributes of the event or one or more relationships between a source of the event and sources of events in the event group.

### BACKGROUND

The present disclosure relates to methods, apparatus, and products for confidence-based event group management, workflow exploitation and anomaly detection. Enterprises may monitor their computing environments using monitoring tools. When these monitoring tools detect particular situations or criteria, they will notify other processes or services by sending an event indicating that the particular situations or criteria have been detected. Event detection may be prone to false positives whereby a detected event may not be indicative of some actual problem or concern.

Various approaches may be used to address potential false positives. For example, filters or de-duplication of events may be used, but this may potentially filter events that may not be significant in isolation but may provide context for other events. As another example, individual rules driving event generation may be deactivated, but this requires manual intervention and is not applicable for machine learning-based tools that do not have specific rules that can be selectively disabled. Accordingly, it may be beneficial to address how events are processed and managed to reduce false positives without eliminating contextually important events, as well as process events to detect anomalous behavior.

### SUMMARY

According to an aspect of the invention, there is provided a method that includes: detecting an event in a computing system; adding the event to an event group; and calculating a group confidence level for the event group based on an event confidence level for the event and at least one of: one or more attributes of the event or one or more relationships between a source of the event and sources of events in the event group. This provides the advantage of grouping contextually relevant events together and calculating a confidence level for the events in aggregate, taking into account the relationships and attributes of the component events when evaluating the confidence for the group as a whole.

In some aspects, the one or more relationships may include one or more transactional relationships or one or more infrastructure relationships. This provides the advantage of allowing technical or infrastructure relationships between entities involved in events to increase the confidence level for the event group.

In some aspects, calculating the group confidence level may include calculating the group confidence level based on whether a source of the event shares one or more relationships with sources of any other events in the event group. This provides the advantage of allowing the confidence level for the event group to reflect shared relationships between sources of events.

In some aspects, the one or more attributes may include an event type or an event source. This provides the advantage of the confidence level for the event group to reflect the event types or event sources for the events in the group.

In some aspects, calculating the group confidence level may include calculating the group confidence level based on whether the event share the one or more attributes with any other events in the event group. This provides the advantage of allowing shared attributes amongst events to affect the overall confidence score for the event group.

In some aspects, the one or more attributes may include an event type and calculating the group confidence level may include applying, to the event confidence level of the event, a growth factor based on a number of other events in the event group sharing the event type with the event. This provides the advantage of scaling the contributions of events sharing an event type to the overall confidence level for the event group as more events sharing the event type are added.

In some aspects, the method may further include decreasing the group confidence level in response to at least one of: an age of events in the event group or adding another event to the event group indicating that the event group is non-anomalous. This provides the advantage of allowing for the group confidence level to degrade should the events in the event group become less relevant due to passage of time or due to an explicit indication that the event group is non-anomalous.

In some aspects, the method may further include applying a biasing vector to a plurality of event confidence levels. This provides the advantage of a more accurate calculation for a group confidence level by applying a bias to the individual event confidence levels.

In some aspects, this method may also include: initiating, based on the group confidence level exceeding a threshold, a workflow; and updating the group confidence level by adding, to the event group, one or more other events based on a result of the workflow. This provides the advantage of initiating the collection of additional information using a workflow in order to further evaluate the confidence level of a group of events, providing a more accurate measure of the confidence level of the group of events.

In some aspects, initiating the workflow may include identifying one or more historical incidents similar to the event group. This provides the advantage of allowing for confidence levels associated with similar incidents to affect the confidence level for the event group.

In some aspects, initiating the workflow may include collecting data from one or more sources of events in the event group. This provides the advantage of allowing for additional, non-event information from relevant entities to affect the confidence level for the event group.

In some aspects, initiating the workflow includes activating one or more inactive monitoring processes. This provides the advantage of selective activation of monitoring processes when a confidence level for an event group reaches a particular threshold, saving on overall computational resource usage by these monitoring processes when not active.

In some aspects, the method may include generating, based on the updated group confidence level, an alert. This provides the advantage of allowing for alerts to be generated where completion of the workflow causes the group confidence level to be updated to a sufficient level.

In some aspects, the method may include providing, based on the updated group confidence level, data describing the event group to a user. This provides the advantage of informing users of particular event groups where completion of the workflow causes the group confidence level to be updated to a sufficient level.

In some aspects, this method may also include: gathering data describing a plurality of metrics across a plurality of time intervals; calculating, for each of the plurality of metrics across and each of the plurality of time intervals, a deviation; calculating, for each of the plurality of time intervals, a sum of the deviation for each of the plurality of metrics to generate a deviation distribution; and determining one or more thresholds based on the deviation distribution. This provides the advantage of training thresholds for identifying anomalous behavior within a particular time interval, allowing for faster identification of anomalous behavior compared to approaches that require tracking of metrics across multiple time intervals.

In some aspects, the method may further include detecting anomalous behavior in the computing system by comparing a sum of deviations for the plurality of metrics in a particular time interval to the one or more thresholds. This provides the advantage of detecting anomalous behavior using information in a single time interval rather than requiring tracking of metrics across multiple time intervals.

In some aspects, this method may also include: gathering data describing a plurality of metrics across a plurality of time intervals; calculating, for each of the plurality of metrics across and each of the plurality of time intervals, a deviation to generate, for each metric of the plurality of metrics, a corresponding deviation distribution; determining, for each of the plurality of metrics and based on the corresponding deviation distribution, a corresponding deviation threshold; calculating, for each time interval of the plurality of time intervals, a count of metrics exceeding their corresponding deviation threshold to generate a metric count distribution; and determining one or more thresholds based on the metric count distribution. This provides the advantage of training thresholds for identifying anomalous behavior within a particular time interval, allowing for faster identification of anomalous behavior compared to approaches that require tracking of metrics across multiple time intervals.

In some aspects, the method may further include detecting anomalous behavior in the computing system by comparing a count of metrics in a particular time interval exceeding their corresponding deviation threshold to the one or more thresholds. This provides the advantage of detecting anomalous behavior using information in a single time interval rather than requiring tracking of metrics across multiple time intervals.

According to an aspect of the invention, there is provided an apparatus including: a processing device; and a memory operatively coupled to the processing device storing computer program instructions that, when executed, cause the processing device to: detect an event in a computing system; add the event to an event group; and calculate a group confidence level for the event group based on an event confidence level for the event and at least one of: one or more attributes of the event or one or more relationships between a source of the event and sources of events in the event group. This provides the advantage of grouping contextually relevant events together and calculating a confidence level for the events in aggregate, taking into account the relationships and attributes of the component events when evaluating the confidence for the group as a whole.

In some aspects, the one or more relationships may include one or more transactional relationships or one or more infrastructure relationships. This provides the advantage of allowing technical or infrastructure relationships between entities involved in events to increase the confidence level for the event group.

In some aspects, calculating the group confidence level may include calculating the group confidence level based on whether a source of the event shares one or more relationships with sources of any other events in the event group. This provides the advantage of allowing the confidence level for the event group to reflect shared relationships between sources of events.

In some aspects, the one or more attributes may include an event type or an event source. This provides the advantage of the confidence level for the event group to reflect the event types or event sources for the events in the group.

In some aspects, calculating the group confidence level may include calculating the group confidence level based on whether the event share the one or more attributes with any other events in the event group. This provides the advantage of allowing shared attributes amongst events to affect the overall confidence score for the event group.

According to an aspect of the invention, there is provided computer program product comprising a computer readable storage medium including computer program instructions that, when executed: detect an event in a computing system; add the event to an event group; and calculate a group confidence level for the event group based on an event confidence level for the event and at least one of: one or more attributes of the event or one or more relationships between a source of the event and sources of events in the event group. This provides the advantage of grouping contextually relevant events together and calculating a confidence level for the events in aggregate, taking into account the relationships and attributes of the component events when evaluating the confidence for the group as a whole.

### BRIEF DESCRIPTION OF THE DRAWINGS

FIG. 1 sets forth a diagram of an example computing environment for confidence-based event group management, workflow exploitation and anomaly detection in accordance with some embodiments of the present disclosure.

FIG. 2 sets forth a flowchart of an example method for confidence-based event group management, workflow exploitation and anomaly detection in accordance with some embodiments of the present disclosure.

FIG. 3 sets forth a flowchart of another example method for confidence-based event group management, workflow exploitation and anomaly detection in accordance with some embodiments of the present disclosure.

FIG. 4 sets forth a flowchart of another example method for confidence-based event group management, workflow exploitation and anomaly detection in accordance with some embodiments of the present disclosure.

FIG. 5 sets forth a flowchart of another example method for confidence-based event group management, workflow exploitation and anomaly detection in accordance with some embodiments of the present disclosure.

FIG. 6 sets forth a flowchart of another example method for confidence-based event group management, workflow exploitation and anomaly detection in accordance with some embodiments of the present disclosure.

FIG. 7 sets forth a flowchart of another example method for confidence-based event group management, workflow exploitation and anomaly detection in accordance with some embodiments of the present disclosure.

FIG. 8 sets forth a flowchart of another example method for confidence-based event group management, workflow exploitation and anomaly detection in accordance with some embodiments of the present disclosure.

FIG. 9 sets forth a flowchart of another example method for confidence-based event group management, workflow exploitation and anomaly detection in accordance with some embodiments of the present disclosure.

FIG. 10 sets forth a flowchart of another example method for confidence-based event group management, workflow exploitation and anomaly detection in accordance with some embodiments of the present disclosure.

FIG. 11 sets forth a flowchart of another example method for confidence-based event group management, workflow exploitation and anomaly detection in accordance with some embodiments of the present disclosure.

FIG. 12 sets forth a flowchart of another example method for confidence-based event group management, workflow exploitation and anomaly detection in accordance with some embodiments of the present disclosure.

FIG. 13 sets forth a flowchart of another example method for confidence-based event group management, workflow exploitation and anomaly detection in accordance with some embodiments of the present disclosure.

FIG. 14 sets forth a flowchart of another example method for confidence-based event group management, workflow exploitation and anomaly detection in accordance with some embodiments of the present disclosure.

FIG. 15 sets forth a flowchart of another example method for confidence-based event group management, workflow exploitation and anomaly detection in accordance with some embodiments of the present disclosure.

FIG. 16 sets forth a flowchart of another example method for confidence-based event group management, workflow exploitation and anomaly detection in accordance with some embodiments of the present disclosure.

### DETAILED DESCRIPTION

The present disclosure relates to methods, apparatus, and products for confidence-based event group management, workflow exploitation and anomaly detection. Enterprises may monitor their computing environments using monitoring tools. When these monitoring tools detect particular situations or criteria, they will notify other processes or services by sending an event indicating that the particular situations or criteria have been detected. Event detection may be prone to false positives whereby a detected event may not be indicative of some actual problem or concern.

Various approaches may be used to address potential false positives. For example, filters or de-duplication of events may be used, but this may potentially filter events that may not be significant in isolation but may provide context for other events. As another example, individual rules driving event generation may be deactivated, but this requires manual intervention and is not applicable for machine learning-based tools that do not have specific rules that can be selectively disabled. Accordingly, it may be beneficial to address how events are processed and managed to reduce false positives without eliminating contextually important events, as well as process events to detect anomalous behavior.

For example, approaches set forth below describe grouping events and calculating a confidence level for the event group based on the relationships and attributes of the component events. This allows for a more accurate representation of the confidence level for the group of events by taking into account contextual information for these events. Moreover, this may allow for events that may be of low confidence in isolation to be taken into account when evaluating a group in aggregate, reducing false positives and potentially reducing the need to filter some events. As another example, workflows may be initiated to gather additional information when evaluating groups of events. This allows for additional contextual information to be gathered for evaluating the confidence or severity of a group of events, which may be useful where a group of events may have a confidence or severity level that may warrant further investigation but may not yet trigger alerts or other remedial actions. As a further example, various thresholds may be trained based on the deviations of measured metrics so as to identify anomalous behavior within a single time interval, providing for faster identification compared to approaches that may require measurement of metrics across multiple time intervals, and also allows for identification of anomalous spikes in metrics across a shorter period of time.

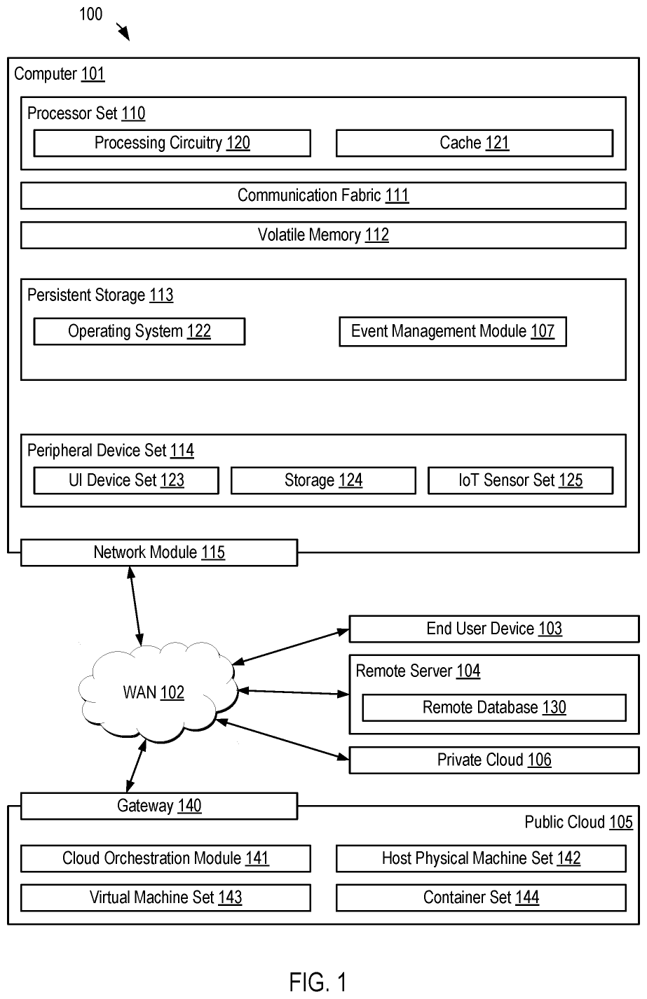

FIG. 1 sets forth an example computing environment according to aspects of the present disclosure. Computing environment 100 contains an example of an environment for the execution of at least some of the computer code involved in performing the various methods described herein, such as an event management module 107. In addition to an event management module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

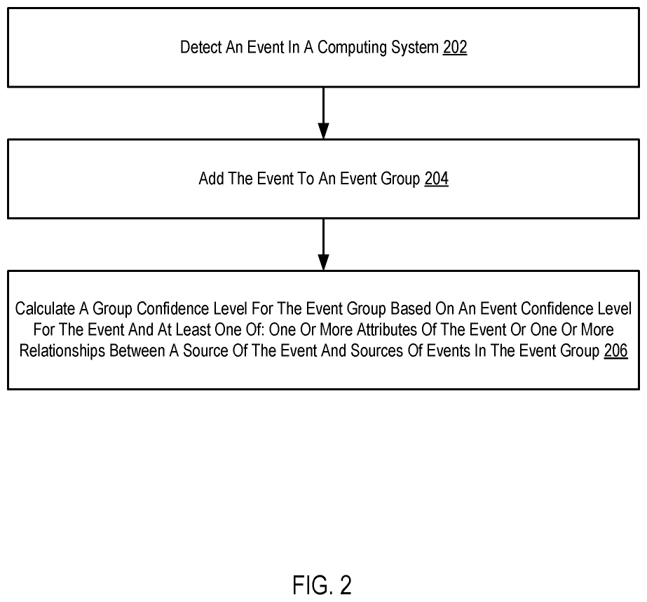

For further explanation, FIG. 2 sets forth a flowchart of an example method for confidence-based event group management, workflow exploitation and anomaly detection in accordance with some embodiments of the present disclosure. The method of FIG. 2 may be performed, for example, by the event management module 107 of FIG. 1. The method of FIG. 2 includes detecting 202 an event in a computing system. The computing system may include any type or configuration of computing system as can be appreciated, including individual hardware devices, multiple devices in a computing environment or deployment, cloud-based or virtualized computing systems, and the like. In some embodiments, various processes or services may monitor various aspects of the computing system, including particular metrics or key performance indicators (KPIs), transactions or activity, and the like. Where a particular condition or situation is detected, the process or service monitoring the computing system may generate an “event” that may then be detected 202 by some other process or service as can be appreciated, such as an event management system (e.g., the event management module 107 of FIG. 1).

The method of FIG. 2 also includes adding 204 the event to an event group. In some embodiments, events may be grouped using a variety of techniques or approaches. For example, in some embodiments, events may be grouped using temporal correlation whereby if two or more events occur at the same time or substantially the same time, these events may be related to each other and therefore grouped together. As another example, in some embodiments, events may be grouped using rule-based correlation whereby one or more user-defined rules may be used to group events based on attributes of the event. As a further example, in some embodiments, events may be grouped using similarity-based correlation whereby the similarity between two events may be calculated (e.g., using text similarity analysis, similarity between specific fields of the event or another approach) and the events may be grouped together where their similarity exceeds some threshold. As yet another example, in some embodiments, events may be grouped using topological correlation whereby events may be grouped based on having some relationship according to a defined topology (e.g., where the sources of the events are topologically related). One skilled in the art will appreciate that these approaches for grouping events are merely illustrative and that other approaches are also contemplated within the scope of the present disclosure.

Accordingly, the event may be added 204 to the event group where the particular approach for grouping events determines that the event should be added to some event group. In some embodiments, the approach used for grouping events may be unable to identify any other event with which the event should be grouped. In such embodiments, adding 204 the event to the event group may include adding the event to a new, empty event group, thereby creating an event group including only the event.

The method of FIG. 2 also includes calculating 206 a group confidence level for the event group based on an event confidence level for the event and at least one of: one or more attributes of the event or one or more relationships between a source of the event and sources of events in the event group. An event confidence level (e.g., a confidence level for the event) is a score or rating reflecting a degree to which the event may be significant (e.g., by virtue of indicating anomalous or malicious behavior or activity, or according to other criteria). For example, in some embodiments, the event confidence level may be correlated with or indicative of a severity for the event. As a further example, in some embodiments, the event confidence level maybe be correlated with the likelihood of the event could cause disruption of application or service. In another embodiment, the event confidence level maybe correlated to whether the user should pay attention or spend time to investigate the event. An event is typically trigger based on some criteria or algorithm, and the confidence of an event could also be influenced by the attribute of the event, criteria or algorithm. For example, certain criteria could have a very specific and pin-pointed detection such as “CPU Time above 90%, transaction response time is increasing, transaction queue is increasing, logs is show messages related to deadlock”, and this could have a higher confidence level. In another example, certain criteria or algorithm could be very generalized, for example, “CPU Time is 2 standard deviations above the training data” is a very generalized algorithm; also, CPU Time is seldomly considered a sole/primary indicator of a problem, and this could have a lower confidence level. The group confidence level is a similar score or rating (e.g., of severity or another attribute) applied to the event group in aggregate rather than an individual event.

The group confidence level for an event group may be calculated based on a variety of factors related to the events within that event group. Put differently, rather than a mere aggregation of the event confidence levels of the events in the event group, the group confidence level also reflects the attributes and/or relationships between the events in the event group. In some embodiments, events may be categorized or classified according to an event type. In some embodiments, an event is generated by some computer software based on some detection on a source such as database or database table. In some further embodiments, an event type could be defined by any combination of the computer software generating the event, the algorithm or criteria used by the computer software to generate the event, the type of source that the event is associated with, and the specific instance of a source. In some embodiments, an event type may be associated with an importance level, which indicates the amount of influence an event's confidence have on the event group. The importance level could be manually defined by a user, learnt based on a feedback loop, automatically determined using other technical such as machine learning or generative AI, or any combination of the techniques. Accordingly, in some embodiments, the event confidence level for an event group may increase over time as events of the same type are added to the event group. As will be described in further detail below, this may include scaling the event confidence levels for these events with a growth factor that increases over time as additional events of the same event type are added to the event group.

In some embodiments, events may be associated with a particular source, such as a monitored entity (e.g., an application, a transaction, a database, a physical storage device, a logical storage unit or other resource as can be appreciated) that caused the event to be generated. Accordingly, in some embodiments, there can be specific situation that triggers event (e.g. high CPU time, or high transaction response time) on a resource. In some embodiments, the specific situation occurring over time might be represented by generating an event each time an evaluation happens (e.g. periodically, once a minute); and no event will be generated after the situation has stopped. In further embodiments, the situation might be represented by generating an “starting of event” at the onset of the situation; and an “ending of event” after the situation has stopped. In some embodiment, if the situation is represented as “start of event” and “end of event”, the event group could handle this representation as if an event is generated periodically. The group confidence level may change (increase or decrease) as specific situation continue for an extended period of time. In some embodiments, if a situation is caused by random spikes that lasted a short time, the group confidence will not built-up into something significant. In some further embodiments, if a situation has continued for an extended period of time, then it could cause end user dissatisfaction or adversely affect other workload (e.g. if an application consume too much CPU, it could ended up taking away CPU from other application). Therefore, the group confidence will built-up into something significant. In some further embodiment, certain event might indicate “positive” situation. Therefore, the group confidence level could decrease as the event happens. In some embodiments, when an event is repeated over time, the confidence contributed by the event could be adjusted for each additional occurrence of the event (called growth factor).

In some embodiments, the group confidence level may change as events of different types having a same source added to the event group. In some embodiments, multiple software or algorithms can be used to detect different situations for a source. When each new situation is detected on a source, the group confidence level will get a boost. For example, when high CPU time is detected on an application, and an event is generated. Then transaction with high response time is detected on the application, and an event is generated. The event group confidence will get a boost for the new situation or event type. In some embodiment, the amount of boost depends on the relationship between the situations that triggered the event. If the situations are orthogonal to each other, the boost will be more significant comparing to situations that have overlaps with each other. The boost could be manually defined by a user, learnt through some feedback loop, automatically determined using other technical such as machine learning or generative AI, or any combination of the techniques.

In some embodiments, events detected from different source might be added to the same event group because these sources may be related (e.g., according to a defined topology, rules, and the like). For example, these sources may be related by transactional relationships where a given source interacts or transacts with another source. As another example, these sources may be related by infrastructure relationships where the sources are related by virtue of the infrastructure or environment in which they are executed. Continuing with this example, these sources may be executed in the same operating system or virtual machine, may belong to a same cluster or other logical grouping, and the like. Accordingly, in some embodiments, the confidence level may increase as events having some relationships are added to the event group. In other words, the event confidence levels of events in an event group may contribute differently (e.g., may contribute greater or lesser) where events in the event group share an event type, share a source, are related, and the like. In some embodiments, the confidence contribution of the current event to an event group confidence level might be boosted based on the relationship between the current event's type and source and the other events and their source already in the event group. In some embodiments, the boost could apply to a group of events with specific relationship. The boost could be manually defined by a user, learnt through some feedback loop, automatically determined using other technical such as machine learning or generative AI, or any combination of the techniques.

In some embodiment, an event could be added to multiple event groups. For example, a database management system could have multiple databases. An event about CPU utilization can be generated on the overall database management system, and separately, two of the databases table (table1 and table2) each have an event related to the response time when writing to the database table. In an example, in some embodiments, 2 event groups could be created: table1 and table 2. The event at the database management system will be included in both the event group for table1 and table2. In further example, in some embodiments, 3 event groups could be created: database management system, table1 and table2. Each of the event group will have their specific event, but the event group for table1 and table2 will have a link with the event group for the database management system. When operations (e.g. confidence calculation) are applied to the database management system event group, these operations could treat the events in table1 and table2 as-if they are part of the database management system event group. When operations are applied to the table1 event group, these operations could treat the events in the database management as-if they are part of table1 event group. Following the same example, in some embodiments, table1 could discover table2 event group by following the linkage with the database management system; and the operation could include the event in table2 event group. In some embodiments, during the operation of table1, it could consider the distance of relationship between event or event group as a factor for the operation. For example, when calculating confidence for table1 event group, it will include the event from the database management system with 60% weight, and it will include the event from table2 with 40% weight.

As an example, the event confidence level for a particular event to be added to an event group may be calculated using the following formula: event_confidence=(base_event_confidence*event_importance*growth_factor[i=event_count(event_type) where base_event_confidence is some predefined confidence value for events of the event type, event_importance is some scalar reflecting the importance of the event, and growth_factor is a scalar based on a number of events in the event group sharing the event type. This growth factor vector will be described in further detail below.

Given the event_confidence for a particular event of a particular event type, the confidence level for events of a particular event type (event_type_confidence) may be calculated as follows: event_type_confidence=sum_of_confidence_from_event_type(event_type_n)*event_type_relationship_weight(relationship_1)* . . . *event_type_relationship_weight(relationship_n). Here, sum_of_confidence_from_event_type(event_type_n) is the sum of event confidence levels for events of the particular event type and event_type_relationship_weight is a weight based on relationships in which events of the particular event type are included. Event_type_relationship_weight(relationship_i)=weight(relationship_i)*scale(count_of_event_type(relationship_i)), where weight(relationship_i) is the weight for a particular type of relationship and scale(count_of_event_type (relationship_i)) is the number of event types involved in the relationship.

Having calculated confidence levels for subsets of events in the event group of a particular event type (event_type_confidence), the group confidence level may be calculated as sum(event_type_confidence). In other words, the group confidence level may be calculated as the summation of the confidence levels for each event type in the event group.

The group confidence level may be used in a variety of approaches. For example, the group confidence level may be used to evaluate the severity of the event group in order to determine whether the event group is indicative of some abnormal or malicious behavior. As another example, where the group confidence level exceeds some threshold, various actions may be taken such as generating an alert, presenting a user with an indication of the event group, performing automated remedial actions, and the like. As another example, an event group could provide both severity and confidence. The severity level is an indication for how serious a problem could be, and confidence level is an indicator for how likely a problem could happen. As another example, a user could base on the event group confidence level and determine if they should further investigate the events within an event group.

The approaches set forth above allow for the calculation of a confidence level for a group of related events. This reflects the significance or severity of the events in aggregate rather than in isolation. Moreover, these approaches leverage the relationships and similarities between events in calculating the confidence level for the group of the events, providing a more accurate evaluation of the group events as opposed to merely aggregating confidence levels for individual events.

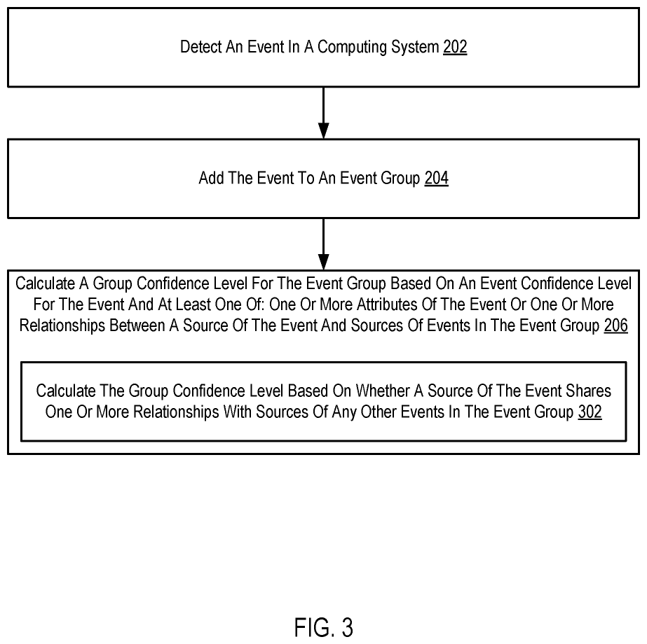

For further explanation, FIG. 3 sets forth a flowchart of another example method of confidence-based event group management, workflow exploitation and anomaly detection in accordance with some embodiments of the present disclosure. The method of FIG. 3 is similar to FIG. 2 in that the method of FIG. 3 also includes: detecting 202 an event in a computing system; adding 204 the event to an event group; and calculating 206 a group confidence level for the event group based on an event confidence level for the event and at least one of: one or more attributes of the event or one or more relationships between a source of the event and sources of events in the event group.

The method of FIG. 3 differs from FIG. 2 in that calculating 206 the group confidence level includes calculating 302 the group confidence level based on whether a source of the event shares one or more relationships with sources of any other events in the event group. As is set forth above, sources of events may be related according to a variety of relationships, such as transactional relationships, infrastructure relationships, and the like. Moreover, in some embodiments, events may be related using different types of these relationships (e.g., different transactional relationships, different infrastructure relationships, and the like). Accordingly, these relationships may determine how events contribute to the overall group confidence level for the event group.

For example, assume an event group with some number of events included. When adding an event to the event group, the group confidence level may increase to a greater degree where the event is related to some other event in the event group. For example, an event confidence level for the event may be scaled by some amount based on the relationship. As another example, referring to the example formula above, the aggregate confidence level for events of a particular event type may be scaled using a scaler corresponding to a particular relationship. In some embodiments, each relationship may have a corresponding scalar that may be different from the scalars for other relationships.

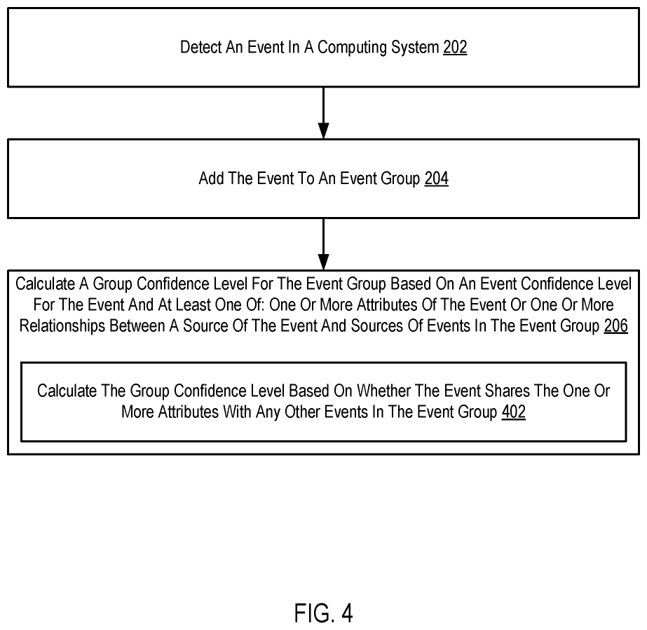

For further explanation, FIG. 4 sets forth a flowchart of another example method of confidence-based event group management, workflow exploitation and anomaly detection in accordance with some embodiments of the present disclosure. The method of FIG. 4 is similar to FIG. 2 in that the method of FIG. 4 also includes: detecting 202 an event in a computing system; adding 204 the event to an event group; and calculating 206 a group confidence level for the event group based on an event confidence level for the event and at least one of: one or more attributes of the event or one or more relationships between a source of the event and sources of events in the event group.

The method of FIG. 4 differs from FIG. 2 in that calculating 206 the group confidence level includes calculating 402 the group confidence level based on whether the event shares the one or more attributes with any other events in the event group. In some embodiments, as events of a same event type may contribute more to the group confidence level as they are added to the event group over time. For example, as will be described in further detail below, events of the same event type may be scaled such that a smaller scalar is applied to the first added event of the event type with progressively increasing scalars applied to subsequently added events of the event type.

In some embodiments, events of an event type not included in the event group may contribute more to the group confidence level than events sharing an event type with events in the group. For example, assume an event group of event type A having a group confidence level of forty. Further assume that events of event type A and B each have an event confidence level of twenty. Adding an event of event type B may cause the group confidence level to increase to sixty while adding an event of event type A may only increase the group confidence level to fifty (e.g., by a lesser amount). In some further embodiments, for the same event source, events of an event type not included in the event group may contribute more to the group confidence level than events sharing an event type with events in the group.

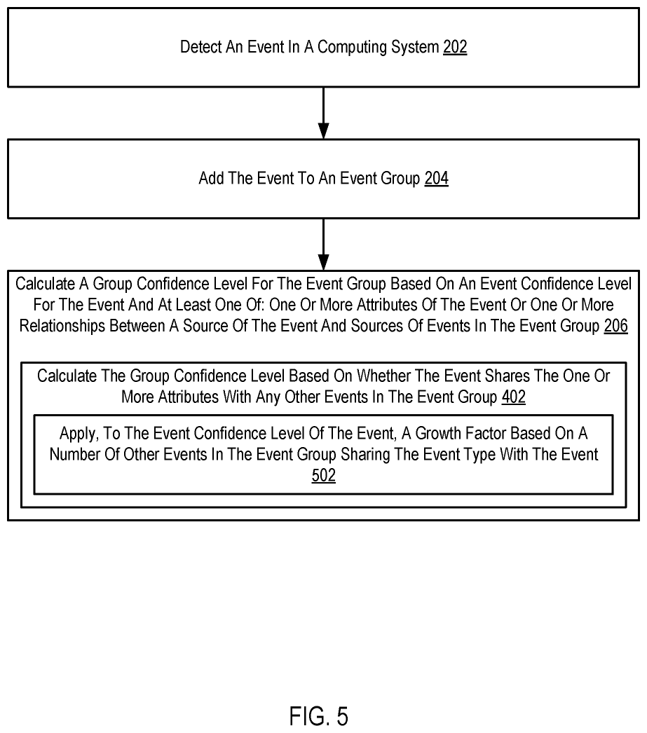

For further explanation, FIG. 5 sets forth a flowchart of another example method of confidence-based event group management, workflow exploitation and anomaly detection in accordance with some embodiments of the present disclosure. The method of FIG. 5 is similar to FIG. 4 in that the method of FIG. 5 also includes: detecting 202 an event in a computing system; adding 204 the event to an event group; and calculating 206 a group confidence level for the event group based on an event confidence level for the event and at least one of: one or more attributes of the event or one or more relationships between a source of the event and sources of events in the event group, including: calculating 402 the group confidence level based on whether the event shares the one or more attributes with any other events in the event group.

The method of FIG. 5 differs from FIG. 4 in that calculating 402 the group confidence level based on whether the event shares the one or more attributes with any other events in the event group includes applying 502, to the event confidence level of the event, a growth factor based on a number of other events in the event group sharing the event type with the event. As is set forth above, a growth factor is a scalar applied to the event confidence level of the event based on a number of other events in the event group sharing the event type with the event. Thus, the overall contribution of the event to the group event score is dependent on the number of other events in the event group sharing the event type with the event.

For example, in some embodiments, the growth factor may be defined in a vector or other data structure of values. In some embodiments, each event type may use a similar vector of growth factors. In some embodiments, each event type may use different vectors of growth factors. As an example, assume a vector of values [⅛, ⅙, ¼, ½, 1, 1, . . . ]. Here, the first added group of a particular event type has its event confidence score scaled down to reduce its contribution to the group confidence level. As subsequent events of the event type are received a progressively increasing growth factor up to some maximum (e.g., one) is applied such that these events contribute more than the previously received occurrences of the same event. While the maximum growth factor in this example is one, readers will appreciate that other arrangements of values in a vector of growth factors may also be used.

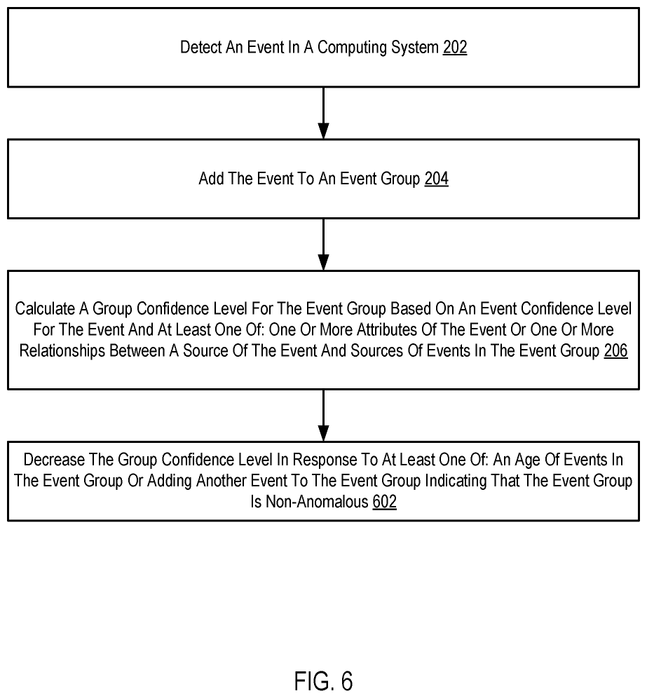

For further explanation, FIG. 6 sets forth a flowchart of another example method of confidence-based event group management, workflow exploitation and anomaly detection in accordance with some embodiments of the present disclosure. The method of FIG. 6 is similar to FIG. 2 in that the method of FIG. 6 also includes: detecting 202 an event in a computing system; adding 204 the event to an event group; and calculating 206 a group confidence level for the event group based on an event confidence level for the event and at least one of: one or more attributes of the event or one or more relationships between a source of the event and sources of events in the event group.

The method of FIG. 6 differs from FIG. 2 in that the method of FIG. 6 also includes decreasing 602 the group confidence level in response to at least one of: an age of events in the event group or adding another event to the event group indicating that the event group is non-anomalous. In some embodiments, an event group may be designated as opened or closed such that events may continue to be added to an open event group and not to a closed event group. Particular criteria for closing an event group may vary according to design or engineering considerations. For example, an event group may be closed when an event is not added to the event group after some amount of time. Where an event group remains open for some amount of time, the event confidence levels for events in the event group itself may be scaled or weighted down based on the amount of time that each event has been included in the event group, based on an age of the event group as a whole, or based on other factors. In further embodiments, the expiration time of an event group could be extended when a new event is added to the group; and the event group will be closed when the expiration time is reached. Furthermore, whether to extend the expiration time or the amount of extension time could be based on attributes of the new event or attributes of events already in the event group. For example, an event group's expiration is extended only if the new event has a severity level of high or above.

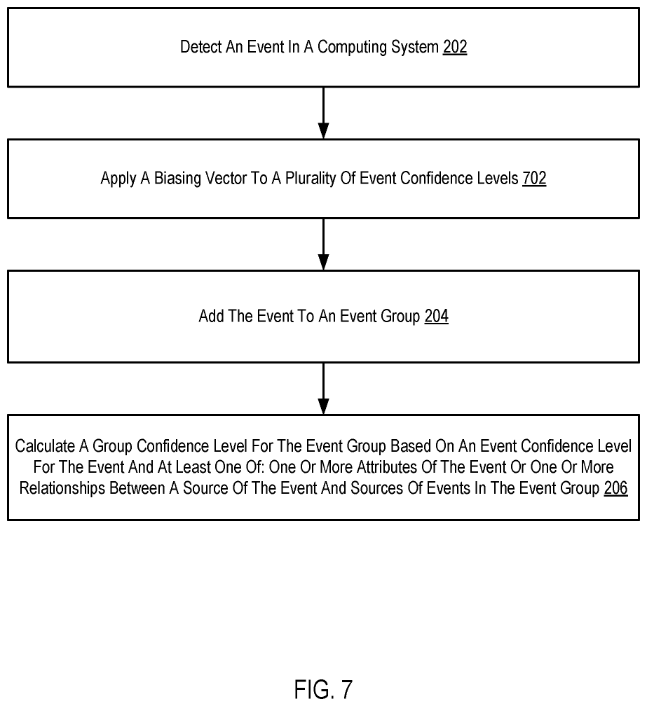

For further explanation, FIG. 7 sets forth a flowchart of another example method of confidence-based event group management, workflow exploitation and anomaly detection in accordance with some embodiments of the present disclosure. The method of FIG. 7 is similar to FIG. 2 in that the method of FIG. 7 also includes: detecting 202 an event in a computing system; adding 204 the event to an event group; and calculating 206 a group confidence level for the event group based on an event confidence level for the event and at least one of: one or more attributes of the event or one or more relationships between a source of the event and sources of events in the event group.

The method of FIG. 7 differs from FIG. 2 in that the method of FIG. 7 also includes applying 702 a biasing vector to a plurality of event confidence levels. Although applying 702 the biasing vector is shown in the context of the approaches set forth above with respect to FIG. 2, readers will appreciate that, in some embodiments, this may be performed independent of the approaches of FIG. 2 and used to calculate group confidence levels according to other approaches or methods. Moreover, although the biasing vector is described as applied to event confidence levels, readers will appreciate that the biasing metric may also be applied to other metrics.

The biasing vector may be generated from a variety of data points. For example, assume a multidimensional vector with dimensions x, y, z such that x corresponds to different time intervals or time stamps, y corresponds to different metrics or KPIs, and z corresponds to different models used to evaluate anomalous KPIs. A point (x,y,z) will include a binary value indicating that an anomaly was found by a particular model for a particular metric at a particular time interval. A two-dimensional vector can be generated from this three-dimensional vector by finding the union of all anomaly flags. Such a two-dimensional vector will have the x and y dimensions, with a value at (x,y) including a binary value indicating whether an anomaly was found by any model for a given KPI at a given time window. A one-dimensional biasing vector may be generated from this two-dimensional vector by vertically slicing the two-dimensional vector (e.g., summing the y-dimension for each x-dimension), with the resulting one-dimensional vector having, at each entry, a count of anomalous KPIs at a particular time stamp.

Applying the biasing vector serves to improve a grouping algorithm by comparing results between one-dimensional vectors after vertical slicing. The event confidence levels may be encoded in a vector multiplied by the biasing vector (e.g., and potentially other values). As an example, assume a vector V. A biased vector V′ may be calculated using the function V′=V*(((g(α))*B)+k), where B is a biasing vector, a is a scale factor applied to B determined as max(V)/max(B), k is a constant offset (e.g., one), and g(α) is a function to adjust the effectiveness of the scale factor with the function being a hyperparameter between zero and one, logarithmic, and sigmoidal.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

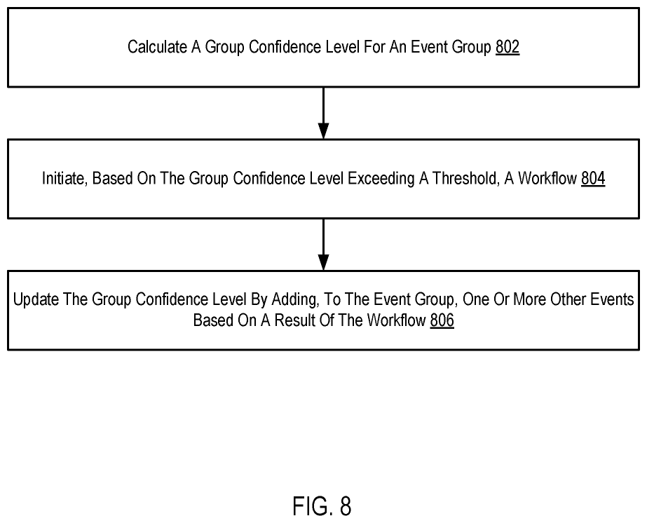

For further explanation, FIG. 8 sets forth a flowchart of another example method of confidence-based event group management, workflow exploitation and anomaly detection in accordance with some embodiments of the present disclosure. The approaches set forth in FIGS. 8-13 may be used in conjunction with, or independent of, the approaches set forth above in FIGS. 2-7. The method of FIG. 8 may be performed, for example, by an event management module 107 of FIG. 1. Although the method of FIG. 8 is described with respect to group confidence levels, one skilled in the art will appreciate that other metrics reflecting the state or status of an event group may also be used. The method of FIG. 8 includes calculating 802 a group confidence level for an event group. In some embodiments, calculating 802 the group confidence level for the event group may be performed using approaches set forth above in FIGS. 2-7. In some embodiments, calculating 802 the group confidence level for the event group may be performed using other approaches.

The method of FIG. 8 also includes initiating 804, based on the group confidence level, exceeding a threshold, a workflow. A workflow includes one or more automated steps performed in response to the workflow being initiated. Particularly, the initiated workflow may include steps to gather non-real-time data or other data not actively monitored when detecting events in the computing system. For example, as will be described in further detail below, the workflow may include steps to aggregate data from various data sources and/or activate monitoring or detecting of different data points. This allows for additional information to be gathered that may be used to affect the group confidence level for the event group. In some embodiments, the workflow may be one of multiple workflows each having a corresponding threshold. Accordingly, in such embodiments, initiating 804 the workflow may include initiating any workflow shoes corresponding threshold is exceeded by the group confidence level. In some embodiments, one or more workflows may be selected and initiated based on other metric or attributes of the event group or event such as severity, event types, event types, event source, the specific abnormal KPIs, the deviation of the abnormal KPIs, the specific log message identifier count or frequency of events, timing of the event, attributes of other resources with infrastructures or applications relationship with the event or event group etc.

The method of FIG. 8 also includes updating 806 the group confidence level by adding, to the event group, one or more other events based on a result of the workflow. In other words, the group confidence level is updated by adding an event to the event group and recalculating the group confidence level. In some embodiments, the data gathered and/or monitored by initiating 804 the workflow may be processed to identify particular conditions or criteria, such as by applying one or more rules to the data or by applying machine learning. Based on the processed data, an event can then be added to the event group. For example, where particular criteria defined in one or more rules are satisfied or a particular machine learning output is generated, an event based on the satisfied rules may be added to the event group. In some embodiment, the type of workflow or the different type of results from a workflow could generate an event with different attributes such as confidence level, severity level or other attributes that could influence attributes of the event group.

In some embodiments, after a workflow-based event is added to the event group, another workflow could be initiated based on the confidence level or other metrics. In further embodiments, the chained workflows can facilitate automated and conditional multi-steps drill down and diagnostics. For example, event group might be created due to elongated access time between an application and a network storage. A workflow can trigger data collection for the high-level performance statistics of the network, network switches, and the storage server. By analyzing the high-level performance statistics, one of the three sources can be identified as primary suspect, and an event could be added to the event group for the primary suspect. Based on the new event in the event group, an additional workflow can be triggered to collect and analyze the detailed statistics for the primary suspect. In some embodiments, the workflow can be triggered to close an event group if the event group is no longer needed. In some combination of embodiments, after a workflow is triggered, an additional workflow can be scheduled to run in the future and attributes of the event group can be updated. For example, a workflow could trigger the addition of available CPU to a system. And additional workflow to reevaluate the situation can be scheduled 20 minutes in the future. In the meantime, the event group's expiration can be set to 30 minutes in the future.

The approaches set forth above allow for workflows to be triggered where the confidence level (or other metric) of an event group exceeds some threshold, thereby gathering additional information and context that may inform the evaluation of the group confidence level. Thus, an event group whose confidence level may not be high enough to trigger an alert or some other remedial action may instead have a workflow initiated. The results of that workflow may then trigger these actions should the updated group confidence level be high enough.

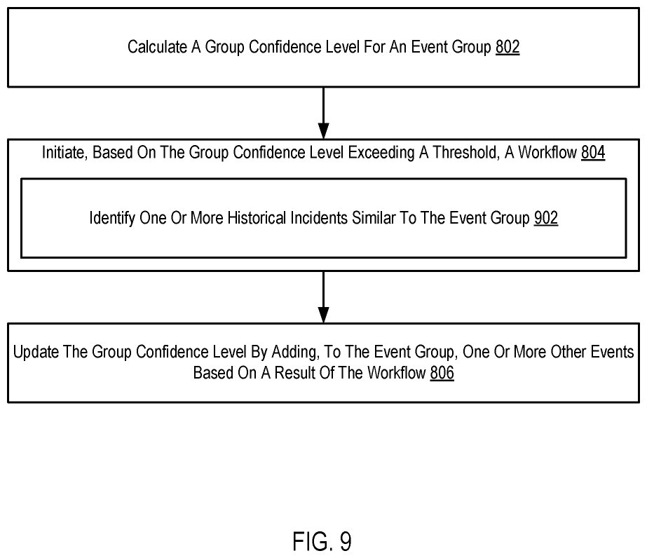

For further explanation, FIG. 9 sets forth a flowchart of an example method of confidence-based event group management, workflow exploitation and anomaly detection in accordance with some embodiments of the present disclosure. The method of FIG. 9 is similar to FIG. 8 in that the method of FIG. 9 includes: calculating 802 a group confidence level for an event group; initiating 804, based on the group confidence level exceeding a threshold, a workflow; and updating 806 the group confidence level by adding, to the event group, one or more other events based on a result of the workflow.

The method of FIG. 9 differs from FIG. 8 in that initiating 804, based on the group confidence level exceeding a threshold, a workflow includes identifying 902 one or more historical or active incidents similar or related to the event group. Identifying 902 one or more incidents may include identifying one or more historical event groups from incident information stored in a database or other data store. The incident information may describe detected events, generated event groups, associated event and group confidence levels, the event source, the root cause of event, the source of the root cause of event, and potentially other information. A similar incident may include, for example, another event group with matching or substantially similar events to those of the event group (e.g., another event group having some calculated degree of similarity exceeding a threshold). A related incident maybe be identified through relationship such as transaction, application, infrastructure relationship, for example, an incident is created based on end user cannot access an application service, and the event group might contain event source that's part of the application service. In response to identifying 902 a incident, an event may be added to the event group that has or indicates a confidence level (or another metric) of the incident, or how the event group confidence should be adjusted. Thus, the confidence level of the similar or related incident may factor into the group confidence level for the event group.

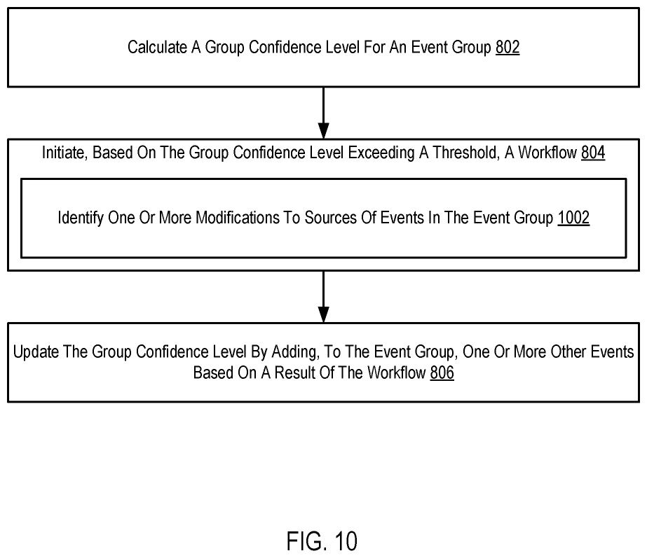

For further explanation, FIG. 10 sets forth a flowchart of an example method of confidence-based event group management, workflow exploitation and anomaly detection in accordance with some embodiments of the present disclosure. The method of FIG. 10 is similar to FIG. 8 in that the method of FIG. 10 includes: calculating 802 a group confidence level for an event group; initiating 804, based on the group confidence level exceeding a threshold a workflow; and updating 806 the group confidence level by adding, to the event group, one or more other events based on a result of the workflow.

The method of FIG. 10 differs from FIG. 8 in that initiating 804, based on the group confidence level exceeding a threshold, a workflow includes identifying 1002 one or more modifications to sources of events in the event group. For example, change logs, update files, or other information describing changes to a particular entity may be accessed to determine if a change was made prior to the events of the event group. Such changes may be the likely cause of the events in the event group. Depending on the nature of the events of the event group and/or the particular changes made, an event can be added to the event group that increases or decreases the group confidence level for the event group. Moreover, should no recent change be identified, an event can be added to the event group that increases or decreases the group confidence level for the event group. In some embodiment, the changes to a particular entity may be identified as a potential root cause, and the specific change can be extracted and made available to the end user.

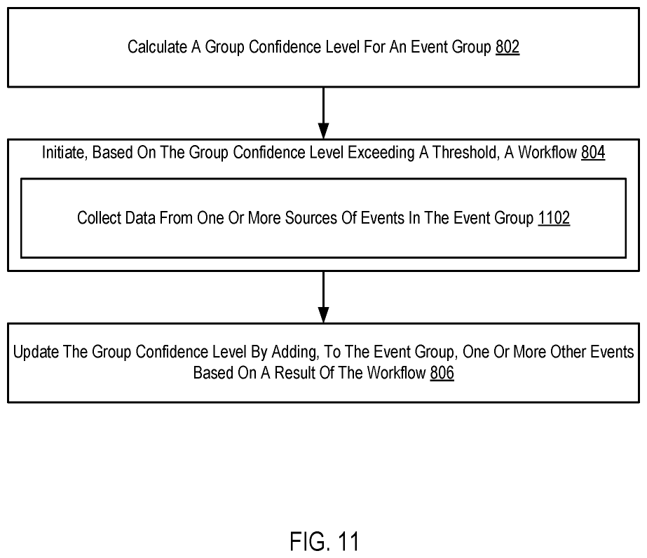

For further explanation, FIG. 11 sets forth a flowchart of an example method of confidence-based event group management, workflow exploitation and anomaly detection in accordance with some embodiments of the present disclosure. The method of FIG. 11 is similar to FIG. 8 in that the method of FIG. 11 includes: calculating 802 a group confidence level for an event group; initiating 804, based on the group confidence level exceeding a threshold, a workflow; and updating 806 the group confidence level by adding, to the event group, one or more other events based on a result of the workflow.

The method of FIG. 11 differs from FIG. 8 in that initiating 804, based on the group confidence level exceeding a threshold, a workflow includes collecting 1102 data from one or more sources of events in the event group. Collection of such data may be temporary such that collection terminates after some amount of time passes or another condition is satisfied. For example, the one or more sources may include one or more sources related according to the various relationships described above. Such data may include, for example, real-time data generated by monitoring activity occurring after the workflow was initiated.

As an example, after excessive CPU usage in a particular subsystem, a workflow may be initiated to collect transactional data for the next two minutes. This transaction data may be analyzed based on transaction identifiers to determine if any particular transaction identifier is a potential contributor to the excessive CPU usage. For example, particular transactions may have higher than normal response times or a particular transaction has an overall higher CPU usage. These transaction identifiers may be indicated in events added to the event group that then cause the group confidence level for the event group to be updated.

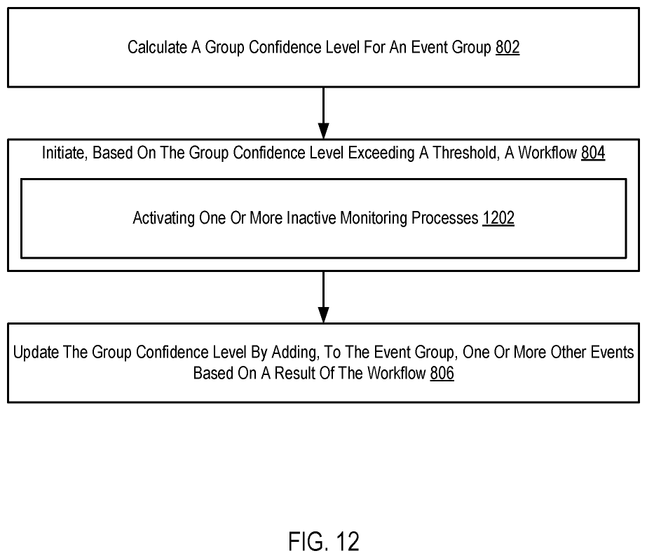

For further explanation, FIG. 12 sets forth a flowchart of an example method of confidence-based event group management, workflow exploitation and anomaly detection in accordance with some embodiments of the present disclosure. The method of FIG. 12 is similar to FIG. 8 in that the method of FIG. 12 includes: calculating 802 a group confidence level for an event group; initiating 804, based on the group confidence level exceeding a threshold, a workflow; and updating 806 the group confidence level by adding, to the event group, one or more other events based on a result of the workflow.

The method of FIG. 12 differs from FIG. 8 in that initiating 804, based on the group confidence level exceeding a threshold, a workflow includes activating 1202 one or more inactive monitoring processes. As described above, various processes may monitor particular metrics or activity to detect particular conditions and, in response, generate events. Here, a previously inactive monitoring process may be activated to potentially identify other events that may be added to the event group. This allows for monitoring processes that may be particularly computationally intensive to be temporarily activated when required rather than continuously run. For example, such monitoring processes may include runtime diagnostics or a diagnostic script that crawls through some set of data.

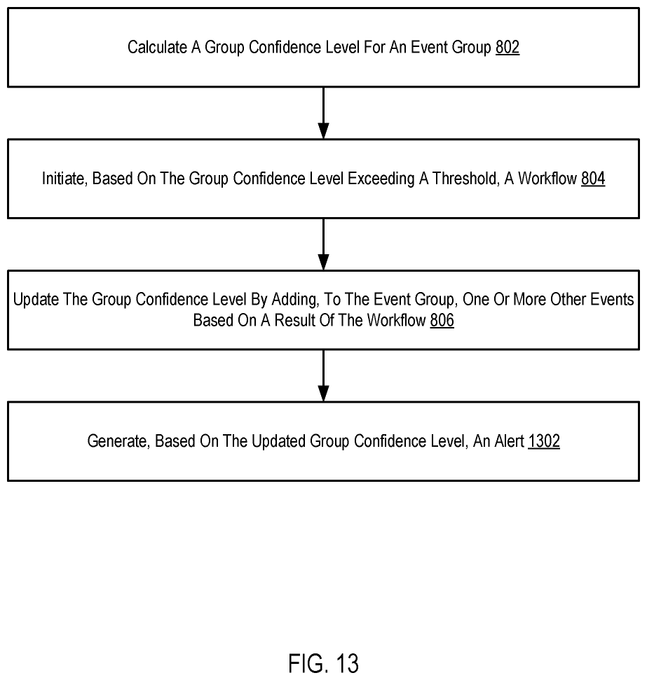

For further explanation, FIG. 13 sets forth a flowchart of an example method of confidence-based event group management, workflow exploitation and anomaly detection in accordance with some embodiments of the present disclosure. The method of FIG. 13 is similar to FIG. 8 in that the method of FIG. 13 includes: calculating 802 a group confidence level for an event group; initiating 804, based on the group confidence level exceeding a threshold, a workflow; and updating 806 the group confidence level by adding, to the event group, one or more other events based on a result of the workflow.

The method of FIG. 13 differs from FIG. 8 in that the method of FIG. 13 also includes generating 1302, based on the updated group confidence level, an alert. In some embodiments, the alert may be generated 1302 in response to the updated group confidence level exceeding some threshold. In some embodiments, generating the alert may include sending a notification or message to a user. In some embodiments, generating the alert may include storing log data or other data indicating the event group. In some embodiments, generating the alert may include sending a command or signal that causes some remedial action to be performed, such as an automated remediation process.

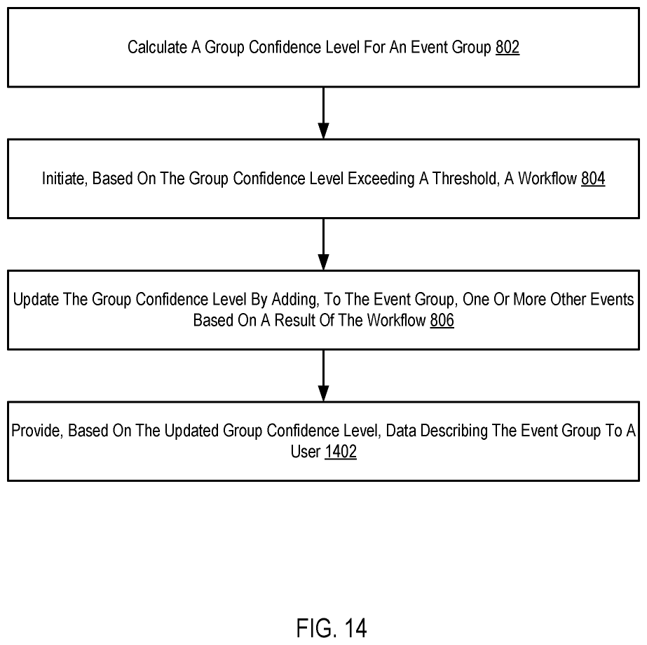

For further explanation, FIG. 14 sets forth a flowchart of an example method of confidence-based event group management, workflow exploitation and anomaly detection in accordance with some embodiments of the present disclosure. The method of FIG. 14 is similar to FIG. 8 in that the method of FIG. 14 includes: calculating 802 a group confidence level for an event group; initiating 804, based on the group confidence level exceeding a threshold, a workflow; and updating 806 the group confidence level by adding, to the event group, one or more other events based on a result of the workflow.

Similar to FIG. 8, a workload could initiate a remediation action, and implement a proposed solution. For example, an event group containing event about high CPU utilization and high transaction response time could trigger a workflow that increase the processor available to a resource. As part of this workflow, it scheduled a future workflow (e.g. in 20 minutes) to verify the situation that triggered one or more the events has improved. Furthermore, this workflow also extends the event group expiration by at least 30 minutes, and set the event group status to “fixing”. The future workflow will verify if the situations causing the event still active. If the result of this future workflow is positive, the workflow could send an event to the event group to reduces the severity or close the event group.

The method of FIG. 14 differs from FIG. 8 in that the method of FIG. 14 also includes providing 1402, based on the updated group confidence level, data describing the event group to a user. In some embodiments, the data describing the event group may be provided 1402 to a user in response to the updated group confidence level exceeding some threshold. Such data may be embodied in a notification or some other message. Such data may indicate, for example, the group confidence level (or other metric) for the event group, the particular events in the event group, the sequence of events, the sequence of workflow, other attributes of the events, the workflow triggered the event or other data associated with the event group. This allows for particular event groups to be surfaced to users in aggregate rather than providing listings or collections of discrete events. For example, an event, event source or KPIs that triggered the event can be labeled a probable root cause. As another example, events and the associated workflow, attribute of the workflow, sequence of workflow execution can be used to provide explanation to the user (e.g. 250 transaction types was narrow down to 2 transaction type based on response time), or scope of impact (e.g. what other application might be impacted because of events within an event group).

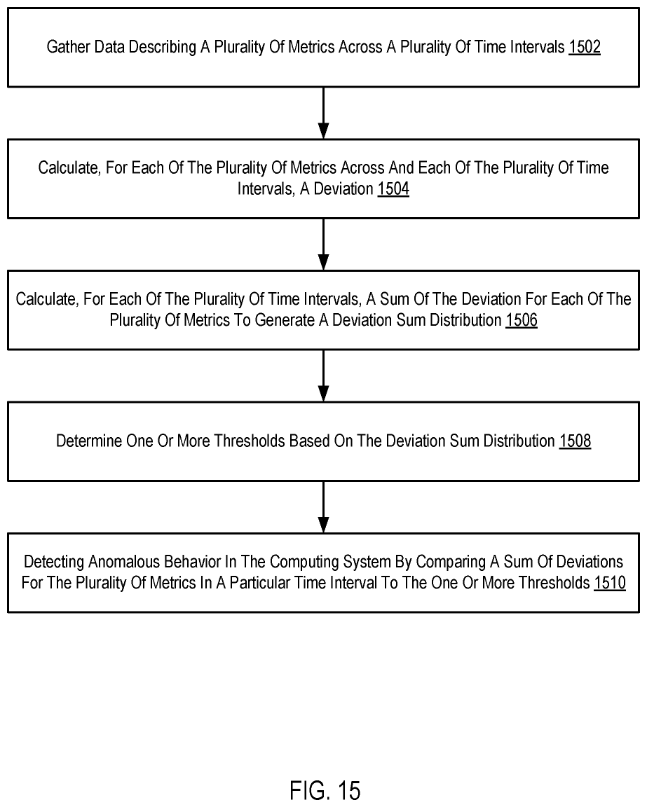

For further explanation, FIG. 15 sets forth a flowchart of another example method of confidence-based event group management, workflow exploitation and anomaly detection in accordance with some embodiments of the present disclosure. The approaches set forth in FIG. 15 may be used in conjunction with, or independent of, the approaches set forth above in FIGS. 2-14. The method of FIG. 15 may be performed, for example, by an event management module 107 of FIG. 1. The method of FIG. 15 includes gathering 1502 data describing a plurality of metrics across a plurality of time intervals. The plurality of metrics may correspond to various metrics or KPIs measured in a computing system. Each time interval may correspond to a particular time stamp or other subdivision of time for which a particular metric is measured.

The method of FIG. 15 also includes calculating 1504, for each of the plurality of metrics and each of the plurality of time intervals, a deviation. In some embodiment, the deviation could be a normalized deviation from normal. For example, normalization allows the deviation of KPI 1 (e.g. raw value has a range of −0.5 to 1.5) comparable with deviation of KPI2 (e.g. raw value has a range of 2000-1 millions). The deviation may include, for example, a number of standard deviations or a number of some other deviations by which a particular metric deviates in a particular time interval relative to other time intervals for that metric. In other words, for each metric at each time interval, a number of deviations is calculated relative to other time intervals for the particular metric. In some further embodiments, the deviation might be calculated based on the summary of a metric over multiple time intervals. The summary may include, for example, rolling average or mean of the values for a metric from the last 10 intervals.

The method of FIG. 15 also includes calculating 1506, for each of the time intervals, a sum of the deviation for each of the plurality of metrics to generate a deviation sum distribution. In other words, the number of deviations across all metrics is summed together for each time interval. Thus, the deviation sum distribution describes the total number of deviations for all metrics as distributed across each of the time intervals. In some embodiments, the sum of deviation could be summarized using other mathematical or statistical methods. For example, the sum of deviation can be implemented as a weighted sum, where the deviation of each metric is multiplied with a weight (e.g. a value such as 1.1, or a percentage such as 80%) specific for that metric. In another example, the sum of deviation could be implemented by removing the metrics with the deviation score at top 5% and bottom 5%, and sum together the deviation of the remaining metrics. In another example, the sum of deviation can be implemented by finding the average value of the deviation from each of the plurality of metrics.

The method of FIG. 15 also includes determining 1508 one or more thresholds based on the deviation sum distribution. The one or more thresholds may be determined using statistical analysis or other techniques as can be appreciated. The one or more thresholds may correspond to different percentiles within the deviation sum distribution. For example, one threshold may correspond to the seventy-fifth percentile in the deviation sum distribution, another threshold may correspond to the twenty-fifth percentile in the deviation sum distribution, and the like. Thus, each threshold describes a threshold number of deviations summed across all metrics within a particular time interval. Determining 1508 the one or more thresholds as described above serves to train an algorithm for detecting anomalous behavior by establishing thresholds indicative of anomalous behavior. In some embodiments, the threshold can be adjusted based on seasonality. For example, a threshold can be determined for Monday between 9-10 am, Monday between 10-11 am, and Tuesday between 9-10 am etc. In another example, the seasonality of threshold can be modelled using machine learning method such as ARIMA.

The method of FIG. 15 also includes detecting 1510 anomalous behavior in the computing system by comparing a sum of deviations for the plurality of metrics in a particular time interval to the one or more thresholds. In other words, for some particular time interval, the number of deviations for each metric is calculated and summed, with the total summed value compared to the one or more thresholds. In some embodiments, anomalous behavior may be detected in response to this total summed value exceeding a threshold or, in the case of multiple thresholds, some particular threshold. In some embodiments, the sum of deviation allows the deviation from multiple metrics to be considered together. For example, when a metric having extremely high deviation and other metrics having a low deviation, the deviation sum will have a high value. In another example, when a lot of metrics having a medium deviation, the deviation sum will have a high value. In these examples, a few highly deviated metrics or a lot of medium deviated metrics will both have a high deviation sum indicative of anomalous behavior.

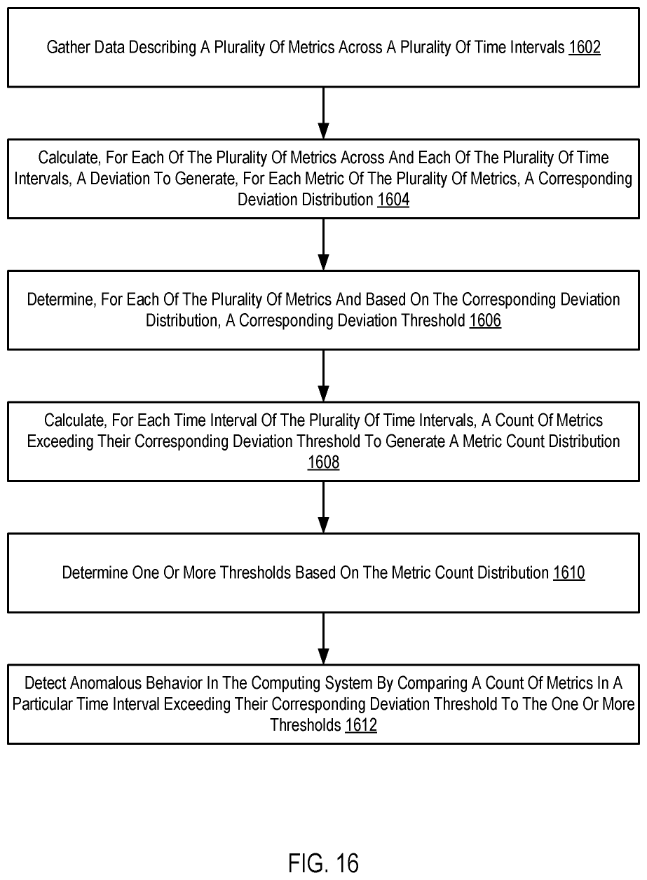

For further explanation, FIG. 16 sets forth a flowchart of another example method of confidence-based event group management, workflow exploitation and anomaly detection in accordance with some embodiments of the present disclosure. The approaches set forth in FIG. 16 may be used in conjunction with, or independent of, the approaches set forth above in FIGS. 2-14. The method of FIG. 16 may be performed, for example, by an event management module 107 of FIG. 1. The method of FIG. 16 includes gathering 1602 data describing a plurality of metrics across a plurality of time intervals. The plurality of metrics may correspond to various metrics or KPIs measured in a computing system. Each time interval may correspond to a particular time stamp or other subdivision of time for which a particular metric is measured.

The method of FIG. 16 also includes calculating 1604, for each of the plurality of metrics and each of the plurality of time intervals, a deviation to generate, for each metric of the plurality of metrics, a corresponding deviation distribution. The deviation for each metric may be calculated according to similar approaches as are set forth above for calculating 1504 a deviation. The corresponding deviation distribution for each metric describes, for the corresponding metric, a number of deviations for the corresponding metric across each time interval.

The method of FIG. 16 also includes determining 1606, for each of the plurality of metrics and based on the corresponding deviation distribution, a corresponding deviation threshold. The corresponding deviation thresholds may be determined as described above using statistical analysis or other techniques. For example, the corresponding deviation thresholds may correspond to different percentiles within the corresponding deviation distribution. Thus, each metric has a corresponding set of deviation thresholds describing a number of deviations for a particular metric in a particular time interval.

The method of FIG. 16 also includes calculating 1608, for each time interval of the plurality of time intervals, a count of metrics exceeding their corresponding deviation threshold to generate a metric count distribution. In other words, for each time interval, a total number of metrics that exceed their corresponding deviation threshold is calculated. Thus, the metric count distribution indicates, for each time interval, how many metrics exceeded their corresponding deviation threshold.

The method of FIG. 16 also includes determining 1610 one or more thresholds based on the metric count distribution. The one or more thresholds may also be calculated as described above using statistical analysis or other techniques. Determining 1610 the one or more thresholds as described above serves to train an algorithm for detecting anomalous behavior by establishing thresholds indicative of anomalous behavior.

The method of FIG. 16 also includes detecting 1612 anomalous behavior in the computing system by comparing a count of metrics in a particular time interval exceeding their corresponding deviation threshold to the one or more thresholds. In other words, for some particular time interval, it may be determined which metrics exceed their corresponding deviation threshold. The count of those metrics is then compared to the one or more thresholds to detect 1612 anomalous behavior (e.g., in response to the count exceeding a threshold).

The approaches set forth above with respect to FIGS. 15 and 16 allow for the detection of anomalous behavior by training thresholds for comparison within a particular time interval. Existing solutions for detecting anomalous behavior may require that some metric be anomalous (e.g., by virtue of having a number of deviations exceeding a threshold or by some other criteria) across some number of time intervals, such as three-out-of-four consecutive time intervals. This may prevent the detection of anomalous behavior that may only cause a significant change in metrics within a short duration, such as a single time interval. Moreover, this approach requires the passage of multiple time intervals before anomalous behavior can be identified. Where the time intervals are longer, such as every fifteen minutes, this may create a prohibitively long minimum wait time before identifying anomalous behavior (e.g., a minimum of forty-five minutes for three-out-of-four fifteen-minute time intervals). In contrast, the approaches set forth above allow for detection of anomalous behavior within a single time interval, allowing for detections of anomalous temporary spikes or changes in measured metrics. In some embodiments, the approaches set forth in FIGS. 15 and 16 could be used to represent two different measurements within a particular time interval for a source. One of the measurements could be used to represent the severity of a source, and the other measurement could be used to represent the confidence of a source. In some embodiments, based on the severity level and confidence level of the source, events can be generated over multiple intervals. The event can have multiple attributes, such as source identifier, source type, algorithm, the severity level and confidence level. The one or more events can be added to an event group over time, and each event's confidence can influence the confidence level of the event group.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting an event in a computing system;
adding the event to an event group; and
calculating a group confidence level for the event group based on an event confidence level for the event and at least one of: one or more attributes of the event or one or more relationships between a source of the event and sources of events in the event group.

2. The method of claim 1, wherein the one or more relationships comprise one or more transactional relationships or one or more infrastructure relationships.

3. The method of claim 1, wherein calculating the group confidence level comprises calculating the group confidence level based on whether a source of the event shares one or more relationships with sources of any other events in the event group.

4. The method of claim 1, wherein the one or more attributes comprise an event type or an event source.

5. The method of claim 1, wherein calculating the group confidence level comprises calculating the group confidence level based on whether the event shares the one or more attributes with any other events in the event group.

6. The method of claim 5, wherein the one or more attributes comprise an event type and wherein calculating the group confidence level comprises applying, to the event confidence level of the event, a growth factor based on a number of other events in the event group sharing the event type with the event.

7. The method of claim 1, further comprising decreasing the group confidence level in response to at least one of: an age of events in the event group or adding another event to the event group indicating that the event group is non-anomalous.

8. The method of claim 1, further comprising applying a biasing vector to a plurality of event confidence levels.

9. The method of claim 1, further comprising:
initiating, based on the group confidence level exceeding a threshold, a workflow; and
updating the group confidence level by adding, to the event group, one or more other events based on a result of the workflow.

10. The method of claim 9, wherein initiating the workflow comprises identifying one or more historical incidents similar to the event group.

11. The method of claim 9, wherein initiating the workflow comprises identifying one or more modifications to sources of events in the event group.

12. The method of claim 9, wherein initiating the workflow comprises collecting data from one or more sources of events in the event group.

13. The method of claim 9, wherein initiating the workflow comprises activating one or more inactive monitoring processes.

14. The method of claim 9, further comprising generating, based on the updated group confidence level, an alert.

15. The method of claim 9, further comprising providing, based on the updated group confidence level, data describing the event group to a user.

16. The method of claim 9, further comprising:
gathering data describing a plurality of metrics across a plurality of time intervals;
calculating, for each of the plurality of metrics across and each of the plurality of time intervals, a deviation;
calculating, for each of the plurality of time intervals, a sum of the deviation for each of the plurality of metrics to generate a deviation sum distribution; and
determining one or more thresholds based on the deviation sum distribution.

17. The method of claim 16, further comprising detecting anomalous behavior in the computing system by comparing a sum of deviations for the plurality of metrics in a particular time interval to the one or more thresholds.

18. The method of claim 9, further comprising:
gathering data describing a plurality of metrics across a plurality of time intervals;
calculating, for each of the plurality of metrics across and each of the plurality of time intervals, a deviation to generate, for each metric of the plurality of metrics, a corresponding deviation distribution;
determining, for each of the plurality of metrics and based on the corresponding deviation distribution, a corresponding deviation threshold;
calculating, for each time interval of the plurality of time intervals, a count of metrics exceeding their corresponding deviation threshold to generate a metric count distribution; and
determining one or more thresholds based on the metric count distribution.

19. The method of claim 18, further comprising detecting anomalous behavior in the computing system by comparing a count of metrics in a particular time interval exceeding their corresponding deviation threshold to the one or more thresholds.

20. An apparatus comprising:
a processing device; and
memory operatively coupled to the processing device, wherein the memory stores computer program instructions that, when executed, cause the processing device to:
detect an event in a computing system;
add the event to an event group; and
calculate a group confidence level for the event group based on an event confidence level for the event and at least one of: one or more attributes of the event or one or more relationships between a source of the event and sources of events in the event group.

21. The apparatus of claim 20, wherein the one or more relationships comprise one or more transactional relationships or one or more infrastructure relationships.

22. The apparatus of claim 20, wherein, to calculate the group confidence level, the instructions, when executed, further cause the processing device to calculate the group confidence level based on whether a source of the event shares one or more relationships with sources of any other events in the event group.

23. The apparatus of claim 20, wherein the one or more attributes comprise an event type or an event source.

24. The apparatus of claim 20, wherein, to calculate the group confidence level, the instructions, when executed, further cause the processing device to calculate the group confidence level based on whether the event shares the one or more attributes with any other events in the event group.

25. A computer program product comprising a computer readable storage medium, wherein the computer readable storage medium comprises computer program instructions that, when executed:
detect an event in a computing system;
add the event to an event group; and
calculating a group confidence level for the event group based on an event confidence level for the event and at least one of: one or more attributes of the event or one or more relationships between a source of the event and sources of events in the event group.
